(19) United States
(12) Patent Application Publication
(10) Pub. No.: US 2015/0373121 A1
(43) Pub. Date: Dec. 24, 2015

(54) WIRELESS PASSENGER SERVICE SYSTEM

(71) Applicant: Northwest Aerospace Technologies, Inc., Everett, WA (US)

(72) Inventor: Seckin Kemal Secilmis, Everett, WA (US)

(21) Appl. No.: 14/748,109

(22) Filed: Jun. 23, 2015

Related U.S. Application Data
(60) Provisional application No. 62/015,974, filed on Jun. 23, 2014.

(51) Int. Cl. H04L 29/08; B64D 11/00

(52) U.S. Cl. CPC H04L 67/12; B64D 11/0015; H04W 84/12

(57) ABSTRACT

A wireless passenger service system for an aircraft having a power system and a cabin management system that includes a wireless receiver and a wireless passenger control unit. The wireless receiver is able to receive a wireless signal and is operationally connected to the power and cabin management systems of the aircraft. The wireless passenger control unit is able to send a wireless signal. In response to receiving a wireless signal from the wireless passenger control unit, the wireless receiver is configured to activate at least one passenger service function of the cabin management system of the aircraft.

### CROSS REFERENCE TO RELATED APPLICATIONS

This application claims the benefit of U.S. Provisional Application No. 62/015,974 filed Jun. 23, 2014, which is herein incorporated by reference in its entirety.

### FIELD OF THE INVENTION

The present invention relates generally to a wireless passenger service system for an aircraft, and more particularly to a wireless passenger service system for wirelessly transmitting a signal communicating basic passenger service functions, such as attendant call or turning a reading light on or off.

### BACKGROUND OF THE INVENTION

Airlines are under constant pressure to reduce their operating costs. A common way to save on operating costs is by reducing the weight of an aircraft. By reducing weight, airlines are able to reduce fuel costs. With fuel costs being substantial, airlines need a way to stay competitive and remain profitable.

FAA regulations require that airlines provide passengers with an in-seat passenger service system that communicates basic passenger service functions, such as calling an attendant and turning reading lights on and off, to an aircraft's control system.

Airlines traditionally provide in-seat passenger service systems that are connected to an aircraft's cabin management system. Such systems typically include a passenger control unit that is installed into a seat and hard-wired to the passenger service system, such that passengers can use the passenger control unit to call an attendant or control a reading light. However, such traditional in-seat passenger service systems have a significant weight cost. The weight cost of wiring a passenger control unit into each seat on an aircraft, and further providing any switches or control units for coordinating the transmission of signals from the passenger control units to the aircraft's cabin management system, can be as much as several thousand pounds.

Accordingly, there is a need for a wireless passenger service system that wirelessly communicates passenger service functions from a passenger control unit to an aircraft's cabin management system, which may weigh less than traditional passenger service systems.

### SUMMARY OF THE PREFERRED EMBODIMENTS

In accordance with a first aspect of the present invention there is provided a wireless passenger service system for an aircraft having a power system and a cabin management system. The wireless passenger service system includes a wireless receiver and a wireless passenger control unit. The wireless receiver is able to receive a wireless signal and is operationally connected to the power and cabin management system of the aircraft. The wireless passenger control unit is able to send a wireless signal. In response to receiving a wireless signal from the wireless passenger control unit, the wireless receiver is configured to activate at least one passenger service function of the cabin management system of the aircraft. In a preferred embodiment, the passenger service functions include at least one of turning a passenger reading light on and off, calling a flight attendant, requesting food and beverage service, controlling the air conditioning, or changing the channels on a video screen. Preferably, the passenger service functions include both turning a passenger reading light on and off and calling a flight attendant. In a preferred embodiment, the wireless receiver and wireless passenger control unit are operationally connected via wi-fi. Preferably, the wireless signal between the wireless passenger control unit and the wireless receiver is encrypted.

In a preferred embodiment, the wireless passenger control unit is a passenger personal electronic device. Preferably, the passenger service functions include at least one of turning a passenger reading light on and off, calling a flight attendant, requesting food & beverage service, controlling the air conditioning, or changing the channels on a video screen. In a preferred embodiment, the system further includes a server providing a web portal and the passenger personal electronic device can access the web portal. In response to user interaction with the web portal through the passenger personal electronic device the passenger personal electronic device sends a wireless signal to the wireless receiver to activate at least one of the passenger service functions. Preferably, the wireless passenger control unit is connected to the power system through in-seat power wiring. In a preferred embodiment, the wireless passenger control unit is connected to the power system through a seat disconnect that allows for the in-seat power wiring to be disconnected from the power system. Preferably, the wireless passenger control unit is associated with a first passenger seat and the at least one passenger service function configured to be activated by the wireless passenger control unit is associated with the first passenger seat. In a preferred embodiment, the present invention provides a second wireless passenger control unit associated with a second passenger seat. In response to receiving a wireless signal from the second wireless passenger control unit, the wireless receiver is configured to activate at least one passenger service function associated with the second passenger seat.

In accordance with another aspect of the present invention, the system provides a user seated in an aircraft seat the ability to activate passenger service functions of a cabin management system of an aircraft by using a wireless passenger control unit to send a wireless signal to a wireless receiver. In response to the wireless receiver receiving the wireless signal from the wireless passenger control unit, the wireless receiver sends a signal to the cabin management system. In response to the cabin management system receiving the signal from the wireless receiver, passenger service functions are activated. In a preferred embodiment, the passenger service functions include at least one of turning a passenger reading light on and off, calling a flight attendant, requesting food & beverage service, controlling the air conditioning, or changing the channels on a video screen. Preferably, the passenger service functions include both turning a passenger reading light on and off and calling a flight attendant.

In a preferred embodiment, the wireless signal is sent from the wireless passenger control unit to the wireless receiver via wi-fi. Preferably, the wireless signal is encrypted. In a preferred embodiment, a passenger personal electronic device is used to send a wireless signal to the wireless receiver. Preferably, the user of the passenger personal electronic device is authenticated prior to sending the wireless signal to the wireless receiver. In a preferred embodiment, a server is provided hosting a web portal and the passenger personal electronic device accesses the web portal. In a preferred embodiment, the wireless passenger control unit is connected to the power system through in-seat power wiring. Preferably, the wireless passenger control unit is connected through a seat disconnect that allows for the wiring in a seat of the aircraft unit to be quickly disconnected from the power system. In a preferred embodiment, an application is downloaded to the passenger personal electronic device that provides a user interface that the user interacts with in order to initiate the sending of a wireless signal.

The present invention is a wireless passenger service system that can be used for wirelessly sending signals to an aircraft's cabin management system.

Further, as personal electronic devices (PEDs) such as tablet computers are becoming more prevalent, airlines can integrate passengers' PEDs with a wireless passenger service system, allowing passengers to use their own PED instead of a passenger control unit. Doing so can eliminate the need for seat to seat power cables and in-seat power wiring, which can further reduce the weight of the system.

### BRIEF DESCRIPTION OF THE DRAWINGS

FIG. 1 shows a passenger service system with an airline-provided passenger control unit in accordance with a preferred embodiment of the present invention;

FIG. 2 shows a passenger service system with a PED being used as a passenger control unit in accordance with a preferred embodiment of the present invention; and

FIG. 3 shows a passenger service system having a PED being used as a passenger control unit and a server connected to the cabin management system.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments.

Reference in this specification to “one embodiment” or “an embodiment” means that a particular feature, structure, or characteristic described in connection with the embodiment is included in at least one embodiment of the-disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

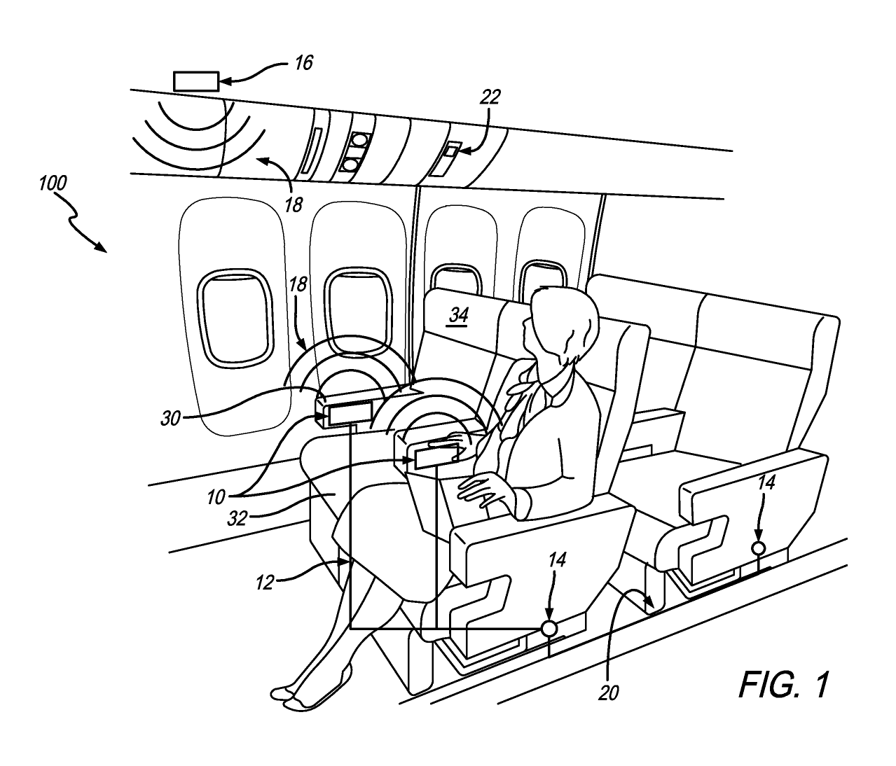

Referring now to the drawings, wherein the showings are for purposes of illustrating the present invention and not for purposes of limiting the same, FIGS. 1-3 show a passenger service system 100 in accordance with preferred embodiments of the present invention.

As shown in FIG. 1, depicting a preferred embodiment of the present invention, a preferred embodiment of the passenger service system 100 includes a wireless passenger control unit 10, in-seat power wiring 12, seat disconnect 14, wireless receiver 16, and seat to seat power cables 20. In a preferred embodiment of the present invention, the seat to seat power cables 20 are connected to an aircraft's power system. In a preferred embodiment, in-seat power wiring 12 connects the seat to seat power cables 20 to the passenger control units 10 such that the passenger control units 10 are connected to and powered by an aircraft's power system. In a further preferred embodiment of the present invention, in-seat power wiring 12 is connected to seat to seat power cables 20 through a seat disconnect 14, which allows for the in-seat power wiring 12 and seat to seat power cables 20 to be quickly disengaged and the seat removed. However, in another embodiment, the seat disconnect 14 can be omitted. It will be appreciated by those of ordinary skill in the art that in another preferred embodiment, the passenger control unit can be battery operated and may not need to be connected to the aircraft's power system via seat to seat power cables 20 and in-seat power wiring 12. Wireless receiver 16 can be a wireless router, wireless device, or a computer for receiving and processing wireless signal 18. In a preferred embodiment, as shown in FIG. 1, wireless receiver 16 is located in an aircraft's passenger service unit channel. However, wireless receiver 16 may be located anywhere else in the aircraft such that it is within range of a wireless signal 18 sent from passenger control unit 10. In a preferred embodiment, passenger control unit 10 is embedded in the armrest 30 of seat 32. In another preferred embodiment, passenger control unit 10 can also be located in the seat back 34. In another preferred embodiment, passenger control unit 10 can also be hand held. In a preferred embodiment, there is one passenger control unit 10 for each seat 32 on the aircraft. In a preferred embodiment, there are multiple wireless receivers 16 such that every wireless receiver 16 is within range of a wireless signal 18 sent from a passenger control unit 10.

When operating the passenger service system 100, a passenger interacts with wireless passenger control unit 10, which sends a wireless signal 18 to wireless receiver 16. By way of example, a passenger seated in seat 15A may wish to activate reading light 22. The passenger may press a button or otherwise interact with the interface of wireless passenger control unit 10 in a manner that indicates that the reading light 22 should be activated. Passenger control unit 10 then sends a wireless signal 18 to wireless receiver 16. Wireless receiver 16 then sends a signal to the aircraft's cabin management system, in response to which the cabin management system activates the reading light 22 associated with seat 15A. It will be appreciated by those of ordinary skill in the art that the passenger service system 100 can be used to activate any other passenger function such as calling a flight attendant, requesting food & beverage service, controlling the air conditioning, or changing the channels on a video screen, by way of non-limiting example. In a preferred embodiment of the present invention, wireless receiver 16 can be connected to the aircraft control system through a router, hub, switch, or other networking device that receives and transmits signals. Preferably, passenger control unit 10 can send and wireless receiver 16 can receive a wireless signal 18 that is in accordance with the wi-fi protocol, Bluetooth protocol, RF protocol, or any other wireless protocol. In a further preferred embodiment of the present invention, wireless signal 18 is an encrypted signal.

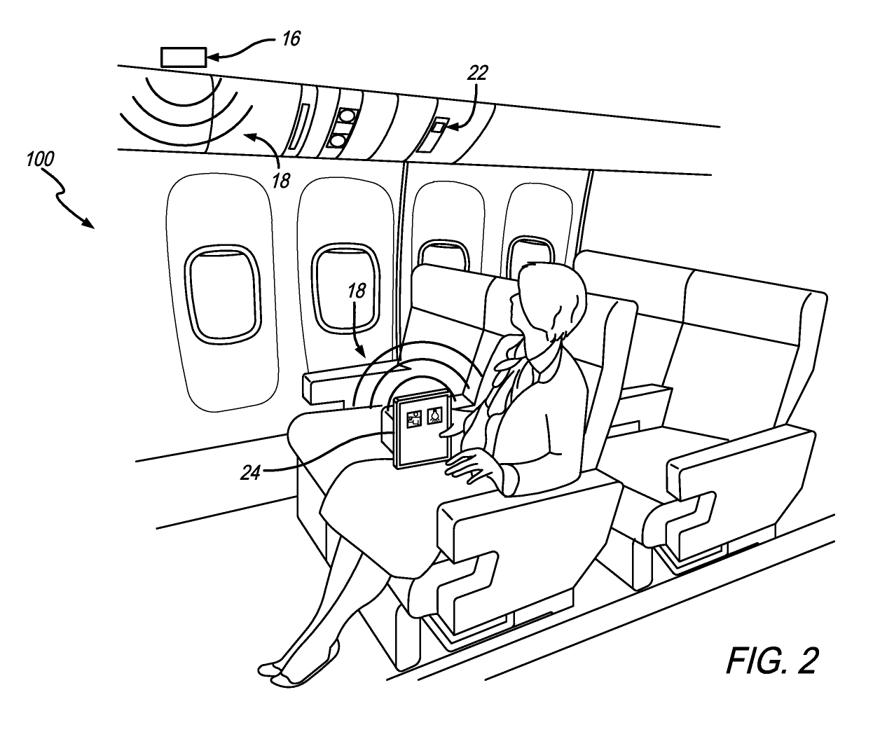

FIG. 2 depicts a second preferred embodiment of the present invention. As shown in FIG. 2, the wireless passenger control unit 10 of FIG. 1 is a passenger PED 24 that sends a wireless signal 18 to wireless receiver 16. Passenger PED 24 can be a tablet, laptop computer, smartphone, or any other device capable of transmitting a wireless signal 18. In accordance with a preferred embodiment of the present invention as shown in FIG. 2, a passenger can interact with passenger PED 24, which in response sends a wireless signal 18 to wireless receiver 16. Wireless receiver 16 then sends a signal to the aircraft's cabin management system, in response to which the cabin management system activates a function such as operating reading light 22.

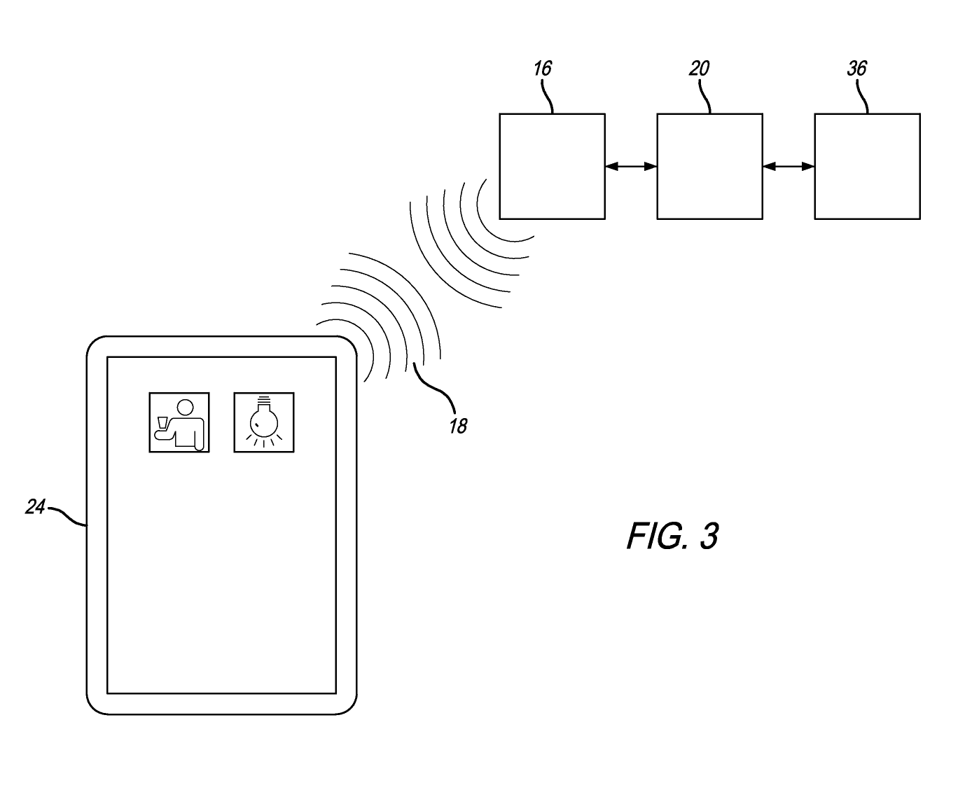

FIG. 3 depicts another preferred embodiment. As shown in FIG. 3, the passenger service system 100 includes a server 20 hosting a web portal, which provides a user interface on passenger PED 24. Passenger PED 24 is wirelessly connected to wireless receiver 16, which is operationally connected through server 20 to the aircraft cabin management system 36. Thus, by way of example, a passenger can open a web browser and load the web portal on passenger PED 24 and interact with the interface provided by the web portal on passenger PED 24. Passenger PED 24 then sends a wireless signal 18 to wireless receiver 16, which then sends a signal to the server 20, which then sends a control signal to the aircraft cabin management system 36.

In another embodiment of the present invention, passenger PED 24 is programmed or includes software that provides a user interface without needing to access a web portal. In a preferred embodiment, a passenger can download and install a software application on passenger PED 24. The software application can be a standalone application which provides a graphical user interface which a passenger can interact with to send a wireless signal 18 from passenger PED 24 to wireless receiver 16 and accordingly activate passenger service functions. In a preferred embodiment, the software application can be downloaded from the Internet prior to boarding. In another embodiment, the software application is the airline's primary mobile application, which provides a feature allowing passengers to control passenger service functions. In another preferred embodiment, the software application can be downloaded from on-board server 20 and installed on passenger PED 24.

In a further preferred embodiment, passenger PED 24 requires the user to authenticate his or her identity or authenticate the associated seat prior to sending wireless signal 18. By way of example, the user may have to enter a specific passcode provided by the airline onto the passenger PED 24 before the passenger PED 24 will allow the user to control the passenger service functions associated with his or her seat. In another preferred embodiment, the user must enter a correct flight confirmation number before being able to control the passenger service functions associated with his or her seat. In another preferred embodiment, the user may provide biometric authentication such as a thumbprint to passenger PED 24 which then authenticates the user and allows the user to control the passenger service functions associated with his or her seat.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize Further, any specific numbers noted herein are only examples: alternative implementations may employ differing values, measurements or ranges.

The teachings of the disclosure provided herein can be applied to other systems, not necessarily the system described above. The elements and acts of the various embodiments described above can be combined to provide further embodiments. Any measurements described or used herein are merely exemplary and not a limitation on the present invention. Other measurements can be used. Further, any specific materials noted herein are only examples: alternative implementations may employ differing materials.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A wireless passenger service system for an aircraft having a power system and a cabin management system, the wireless passenger service system comprising:
a wireless receiver operationally connected to the cabin management system of the aircraft, wherein the wireless receiver is able to receive a wireless signal; and
a wireless passenger control unit that is able to send a wireless signal;
wherein in response to receiving a wireless signal from the wireless passenger control unit, the wireless receiver is configured to activate at least one passenger service function of the cabin management system of the aircraft.

2. The system of claim 1, wherein the passenger service function includes at least one of turning a passenger reading light on and off, calling a flight attendant, requesting food and beverage service, controlling air from a gasper, and changing channels on a video screen.

3. The system of claim 1, wherein the passenger service function includes both turning a passenger reading light on and off and calling a flight attendant.

4. The system of claim 1, wherein the wireless receiver and wireless passenger control unit are operationally connected via wi-fi.

5. The system of claim 1, wherein the wireless signal between the wireless passenger control unit and the wireless receiver is encrypted.

6. The system of claim 1, wherein the wireless passenger control unit is a passenger personal electronic device.

7. The system of claim 6, wherein the passenger service function includes at least one of turning a passenger reading light on and off, calling a flight attendant, requesting food and beverage service, controlling air from a gasper, and changing channels on a video screen.

8. The system of claim 6, wherein the system further includes a server providing a web portal;
wherein the passenger personal electronic device can access the web portal;
wherein in response to user interaction with the web portal through the passenger personal electronic device the passenger personal electronic device sends a wireless signal to the wireless receiver to activate at least one passenger service function.

9. The system of claim 1, wherein the wireless passenger control unit is connected to the power system through in-seat power wiring.

10. The system of claim 9, wherein the wireless passenger control unit is connected to the power system through a seat disconnect that allows for the in-seat power wiring to be disconnected from the power system.

11. The system of claim 2 wherein the wireless passenger control unit is associated with a first passenger seat, and wherein the at least one passenger service function configured to be activated by the wireless passenger control unit is associated with the first passenger seat.

12. The system of claim 11 further comprising a second wireless passenger control unit associated with a second passenger seat, wherein in response to receiving a wireless signal from the second wireless passenger control unit, the wireless receiver is configured to activate at least one passenger service function associated with the second passenger seat.

13. A method for activating at least one passenger service function of a cabin management system of an aircraft, the method comprising the steps of:
(a) using a wireless passenger control unit to send a wireless signal to a wireless receiver;
(b) in response to the wireless receiver receiving the wireless signal from the wireless passenger control unit, sending a signal from the wireless receiver to the aircraft's cabin management system; and
(c) in response to the cabin management system receiving the signal from the wireless receiver, activating at least one function of the cabin management system of the aircraft.

14. The method of claim 13, wherein the passenger service function of the cabin management system of the aircraft includes at least one of turning a passenger reading light on and off, calling a flight attendant, requesting food and beverage service, controlling air from a gasper, and changing channels on a video screen.

15. The method of claim 13, wherein the passenger service function of the cabin management system of the aircraft includes both turning a passenger reading light on and off and calling a flight attendant.

16. The method of claim 13, wherein step (a) further comprises sending the wireless signal via wi-fi.

17. The method of claim 13, wherein a passenger personal electronic device is the wireless passenger control unit.

18. The method of claim 17, further comprising the step of:
authenticating the user of the passenger personal electronic device prior to sending the wireless signal to the wireless receiver.

19. The method of claim 17, wherein step (a) further comprises the steps of:
providing a server hosting a web portal;
serving the web portal from the server to the passenger personal electronic device; and
sending the wireless signal in response to a user's interaction with the web portal.

20. The method of claim 17, wherein step (a) further comprises the steps of:
downloading a software application to the passenger personal electronic device;
displaying a graphical user interface on the passenger personal electronic device; and
sending the wireless signal in response to a user's interaction with the graphical user interface.
